(19) United States
(12) Patent Application Publication
(10) Pub. No.: US 2006/0049550 A1
(43) Pub. Date: Mar. 9, 2006

(54) Injection blow molding method for producing plastic containers

(76) Inventor: Chiung-Chi Lin, Taiping City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/935,674

(22) Filed: Sep. 7, 2004

(51) Int. Cl. B29C 49/00

(52) U.S. Cl. 264/537

(57) ABSTRACT

An injection blow molding method for producing plastic containers is to mount a movable mold board and a fixed mold board to an injection molding machine. A base mold board is mounted to the movable mold board and a rotatable mold board is pivotally mounted to the base mold board. An embryo molding station and a shape molding station is disposed between the rotatable mold board and the fixed moldboard. The embryo molding station and the shape molding station can be synchronously operated to form a container embryo and a shaped container at the same time.

### BACKGROUND OF THE INVENTION

1. Field of the Invention

The present invention relates to an injection blow molding method, and more particularly to an injection blow molding method for producing plastic containers.

2. Description of Related Art

Plastic containers are widely used in our daily live, such as for containing drinks or foods. Currently, manufacturers usually produce the plastic container by injection blow molding machine. The conventional producing method needs to previously produce a container embryo and secondarily blow the container embryo for shaping.

The conventional injection blow molding machine comprises a blowing mold, rotatable molding seat and a shaping mold sequentially mounted on the injection blow molding machine and parallel to one another. Two telescopic shafts are disposed on the rotatable mold. A first core mold and a second core mold are respectively mounted to a free end of each of the two telescopic shafts and respectively correspond to the shaping mold and the blowing mold. A hydraulic cylinder is mounted on the shaping mold and corresponds to the blowing mold. The melted material is injected into the shaping mold for covering the first core mold and forming the container embryo after the molds being closed. The rotatable molding seat is rotated to interchange positions of the first core mold and the second core mold after opening the molds. The first core mold with the container embryo is moved to align with the blowing mold and the second core mold is moved to align with the shaping mold. After closing the molds again, the hydraulic cylinder pushes the first core mold to stretch the container embryo and the compressed gas is blew into the container embryo for shaping the container. In addition, the second core mold and the shaping mold form a new container embryo when the container is shaped. Afterwards, the hydraulic cylinder backward moves the telescopic shaft and the shaped container drops when the molds is opened. Laterally, the first core mold and the second core mold are moved to the original positions thereof. To repeat the above steps can continually produce the containers.

However, the convention injection blow molding method for producing plastic containers in accordance with the prior art comprises the following disadvantages.

1. The conventional blowing molds need a unique machine for operating. The shaping mold and the blowing mold are circularly moved relative to the rotatable molding seat for opening and closing the molds. However, the ordinary blowing machine and the injection machine have only one side that is rotatable. As a result, the manufacturer needs to prepare a machine that has two rotatable sides for the conventional blowing method and molds.

2. The shaping mold, the rotatable molding seat and the blowing mold are sequentially transversely disposed relative to one another. In addition, the shaping mold and the blowing mold are laterally moved to fully apart from the first core mold and the second core mold. As a result, the conventional molds need a great operational room.

3. The manufacturer needs to prepare an injection molding machine for producing the container embryo and a unique blow molding machine for shaping the container. Consequently, the manufacturing cost is greatly increased.

The present invention has arisen to mitigate and/or obviate the disadvantages of the conventional injection blow molding method for producing plastic containers.

### SUMMARY OF THE INVENTION

The main objective of the present invention is to provide an improved injection blow molding method for producing plastic containers for greatly decreasing the manufacturing cost.

To achieve the objective, the method in accordance with the present invention comprises the following steps.

1. Closing mold assembly: the fixed mold board and the movable mold board are respectively mounted to the fixed mold seat and the movable mold seat. Each core mold is received in the embryo mold of a corresponding one of the multiple embryo mold station when the mold assembly is closed.

2. Shaping container embryo: the melted material is injected into the embryo mold via the injection nozzle for fully coating the core mold to form a container embryo between the embryo mold and the core mold.

3. Opening the mold assembly: the blowing mold and the embryo mold are firstly opened and the movable mold seat is backward moved to drive the movable mold board, the base mold board and the rotatable mold board moved away from the fixed mold board. As a result, the shaped container embryo is moved apart from the embryo mold. The movable mold board is continually moved after the base mold board being moved to a fixed position to make each core mold and cylinder escape from the rotatable mold board. At this time, the shaped container embryo is fixed on the rotatable mold board.

4. Rotating the rotatable mold board: the rotatable mold board is accurately rotated 180 degrees to make the shaped container embryo centrally align with the blowing mold.

5. Closing the mold assembly again: the movable mold seat is moved toward the fixed mold seat to sequentially the movable mold board, the base mold board and the rotatable mold board to make the rotatable mold board securely abutting against the first thread mold and the second thread mold. At this time, the core mold extends into the embryo mold again and the shaped container embryo is received in the blowing mold.

6. Stretching the telescopic blowing stick and shaping a new container embryo: the telescopic shaft of the cylinder extends to engage to a neck of the shaped container embryo for positioning the shaped container embryo during blowing and shaping. The telescopic blowing stick extends to a bottom of the blowing mold to stretch the shaped container embryo. At this time, the melted material is injected into the embryo mold via the injection nozzle for fully coating the core mold to form a new container embryo between the embryo mold and the core mold.

7. Shaping the container: the compressed air is injected into the stretched container embryo via the telescopic shaft and the telescopic blowing stick to force the container embryo fully abutting an inner periphery of the blowing mold and shape a complete container.

8. Open the mold assembly again: the telescopic shaft is drawn back and then the telescopic stick is drawn back into the telescopic shaft. The blowing mold and the second thread mold are synchronously opened such that the shaped container is detached from the shape molding station, but connected to the telescopic shaft. Finally, the movable mold seat is backward moved to drive the movable mold board, the base mold board and the rotatable mold board moved away from the fixed mold board. The movable mold board is continually moved after the base mold board being moved to a fixed position to make the shaped container automatically detach from the telescopic shaft. The containers can be continually shaped by repeating the step 4 to step 8.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of an injection blow molding method in accordance with the present invention;

FIG. 2 is a cross-sectional view of a mold assembly for the injection blow molding method of the present invention;

FIG. 3 is a cross-sectional view of the mold assembly in FIG. 2 when shaping a container embryo;

FIG. 4 is a cross-sectional view of the mold assembly in FIG. 2 after shaping the container embryo and being opened;

FIG. 5 is a plan view for showing the rotate mold board of the mold assembly in FIG. 2 when being rotating;

FIG. 6 is a cross-sectional view of the mold assembly in FIG. 2 when the container embryo is moved to align with the final molding station;

FIG. 7 is a cross-sectional view of the mold assembly in FIG. 2 when being closed again for shaping a new container embryo and blowing the previous container embryo;

FIG. 8 is a cross-sectional view of the mold assembly in FIG. 7 when shaping a new container embryo and blowing the previous container embryo;

FIG. 9 is a cross-sectional view of the mold assembly in FIG. 8 when finishing shaping a new container embryo and blowing the previous container embryo; and

FIG. 10 is a cross-sectional view of the mold assembly in FIG. 9 when being opened for detaching the shaped container from the mold assembly.

### DETAILED DESCRIPTION OF THE INVENTION

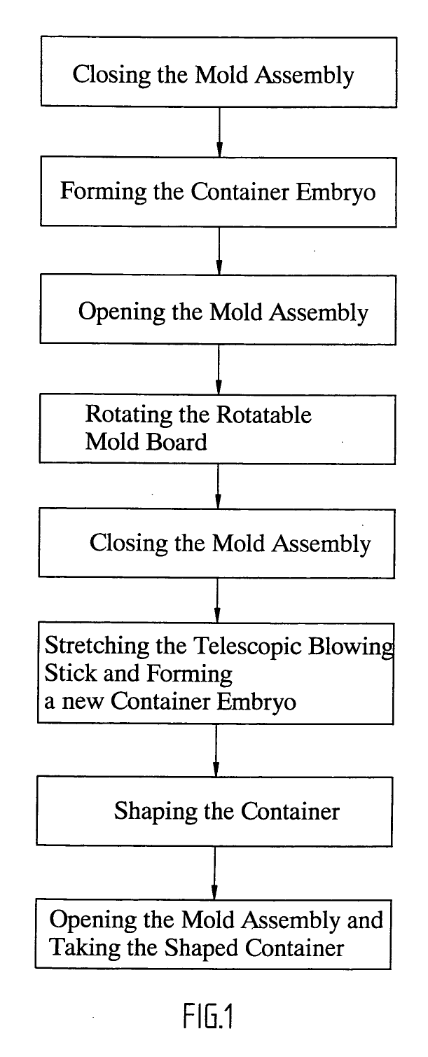

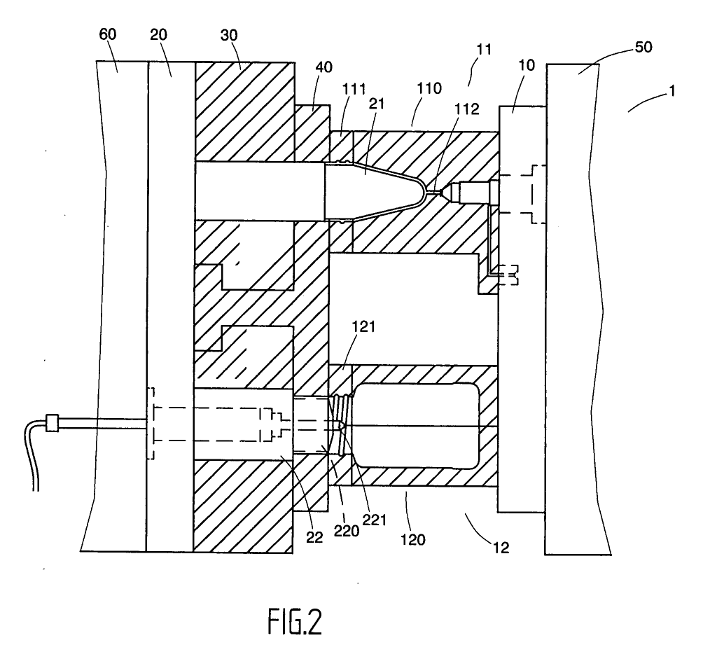

Referring to the drawings and initially to FIGS. 1-2, an injection blow molding method for producing plastic containers in accordance with the present invention uses a mold assembly (1) that is mounted between fixed mold seat (50) and a movable mold seat (60) of an injection molding machine. The mold assembly (1) comprises a fixed mold board (10) and a movable mold board (20) respectively laterally mounted to the fixed mold seat (50) and the movable mold seat (60).

Multiple embryo molding stations (11) and multiple shape molding stations (12) are respectively sequentially disposed on the fixed mold board (10). Each embryo molding station (11) includes an embryo mold (110) longitudinally secured on the fixed mold board (10) and having an inject nozzle (112) defined in the embryo mold (110). The inject nozzle (112) communicate with the inner periphery of the embryo mold (110) and the injection molding machine. A first thread mold (111) is mounted on a free end of each of the embryo molds (110). The first thread mold (111) is equally divided into two portions that are separated relative to each other when the mold assembly (1) is opened. Each shape molding station (12) includes a blowing mold (120) mounted on the fixed mold board (10) and equally divided into two portions that are separated relative to each other when the mold assembly (1) is opened. A second thread mold (121) is mounted on a free end of each of the blowing molds (120) and equally divided into two portions that are separated with the two portions of the blowing mold (120) on which the second thread mold (121) is mounted.

Multiple core molds (21) extend from the movable mold board (20) and each originally aligns with a corresponding one of the multiple embryo molds (110). A free end of each of the multiple core molds (21) is selectively received in the corresponding embryo mold (110) for shaping the container embryo. Multiple cylinders (22) extend from the movable mold board (20) and each originally aligns with a corresponding one of the multiple blowing molds (120). A telescopic shaft (220) is centrally received in a free end of each of the multiple cylinders (22) and a telescopic blowing stick (221) is mounted in each of the multiple telescopic shafts (20). A base mold board (30) is sleeved on the multiple core molds (21) and the multiple cylinders (22), and is disposed on the movable mold board (20). A rotatable mold board (40) is pivotally mounted to the base mold board (30) for exchanging the positions of the multiple core molds (21) and the multiple cylinders (22). The pivot point of the rotatable mold bard (40) centrally corresponds to the multiple embryo molding stations (11) and the multiple shape molding stations (12).

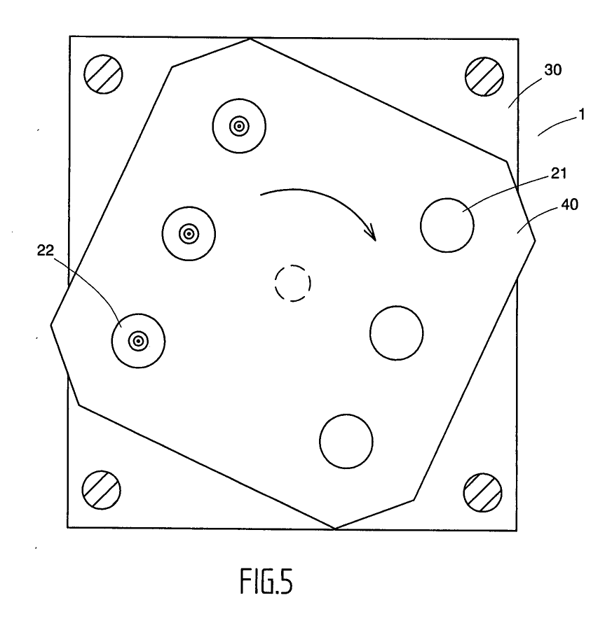

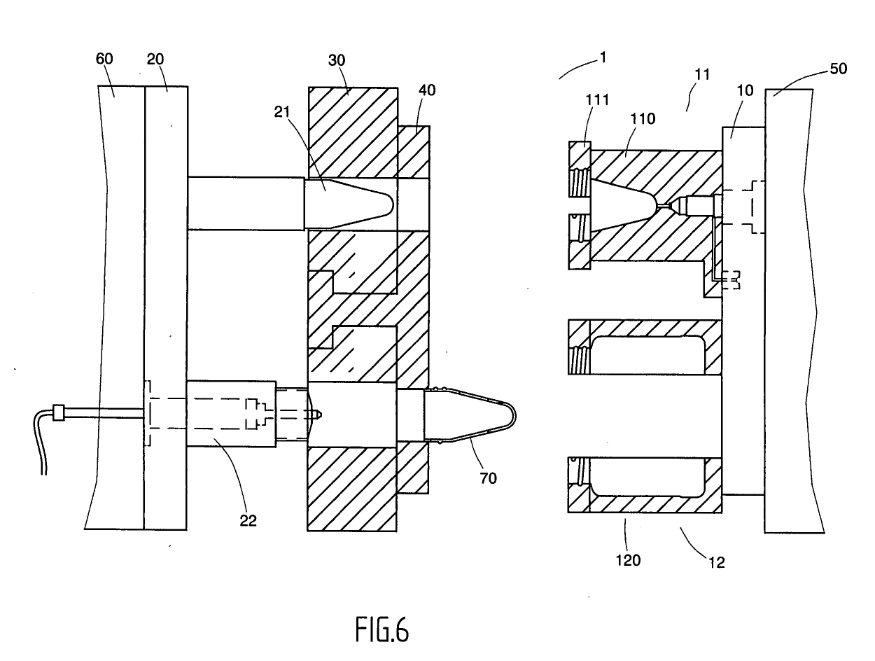

With reference to FIGS. 1-10, the injection blow molding method for producing plastic containers in accordance with the present invention comprises the following steps.

1. Closing mold assembly: the fixed mold board (10) and the movable mold board (20) are respectively mounted to the fixed mold seat (50) and the movable mold seat (60). Each core mold (21) is received in the embryo mold (110) of a corresponding one of the multiple embryo mold station (11) when the mold assembly (1) is closed.

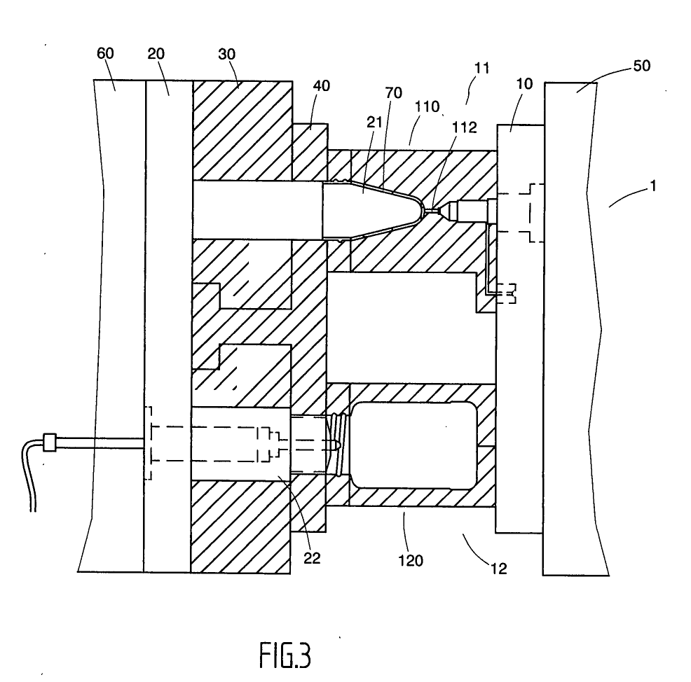

2. Shaping container embryo (70): with reference to FIG. 3, the melted material is injected into the embryo mold (110) via the injection nozzle (112) for fully coating the core mold (21) to form a container embryo (70) between the embryo mold (110) and the core mold (21).

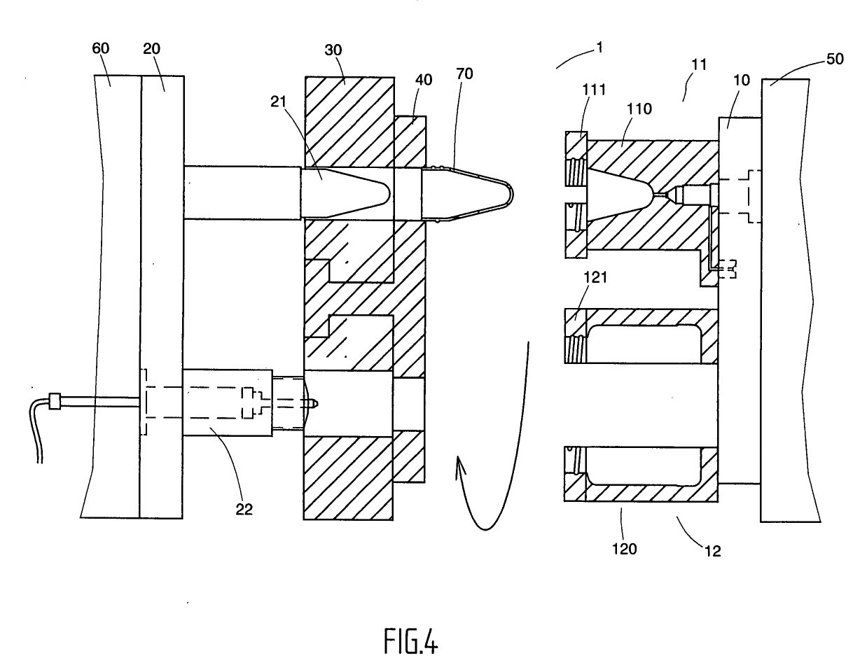

3. Opening the mold assembly: with reference to FIG. 4, the blowing mold (120) and the embryo mold (110) are firstly opened and the movable mold seat (60) is backward moved to drive the movable mold board (20), the base mold board (30) and the rotatable mold board (40) moved away from the fixed mold board (10). As a result, the shaped container embryo (70) is moved apart from the embryo mold (110). The movable mold board (20) is continually moved after the base mold board (30) being moved to a fixed position to make each core mold (21) and cylinder (22) escape from the rotatable mold board (40). At this time, the shaped container embryo (70) is fixed on the rotatable mold board (40).

4. Rotating the rotatable mold board (40): with reference to FIGS. 4-6, the rotatable mold board (40) is accurately rotated 180 degrees to make the shaped container embryo (70) centrally align with the blowing mold (120).

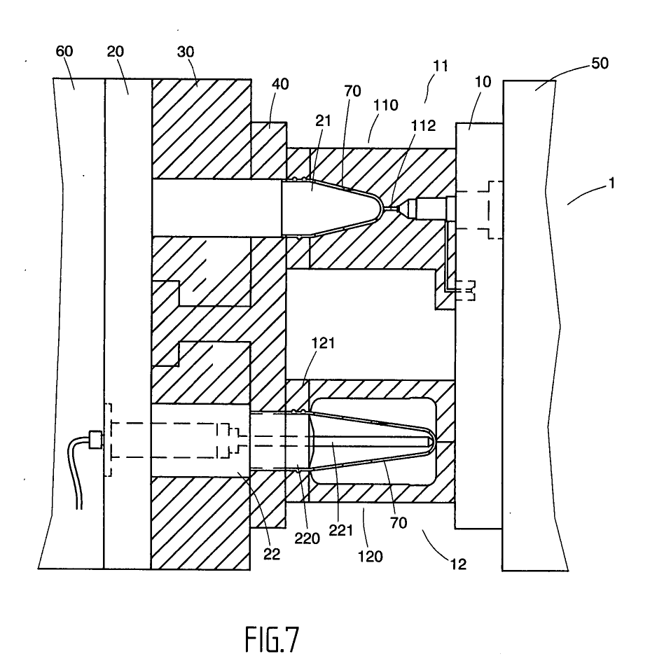

5. Closing the mold assembly (1) again: with reference to FIG. 7, the movable mold seat (60) is moved toward the fixed mold seat (10) to sequentially the movable mold board (20), the base mold board (30) and the rotatable mold board (40) to make the rotatable mold board (40) securely abutting against the first thread mold (111) and the second thread mold (121). At this time, the core mold (21) extends into the embryo mold (110) again and the shaped container embryo (70) is received in the blowing mold (120).

6. Stretching the telescopic blowing stick (221) and shaping a new container embryo (70): with reference to FIG. 7, the telescopic shaft (220) of the cylinder (20) extends to engage to a neck of the shaped container embryo (70) for positioning the shaped container embryo (70) during blowing and shaping. The telescopic blowing stick (221) extends to a bottom of the blowing mold (120) to stretch the shaped container embryo (70). At this time, the melted material is injected into the embryo mold (110) via the injection nozzle (112) for fully coating the core mold (21) to form a new container embryo (70) between the embryo mold (110) and the core mold (21).

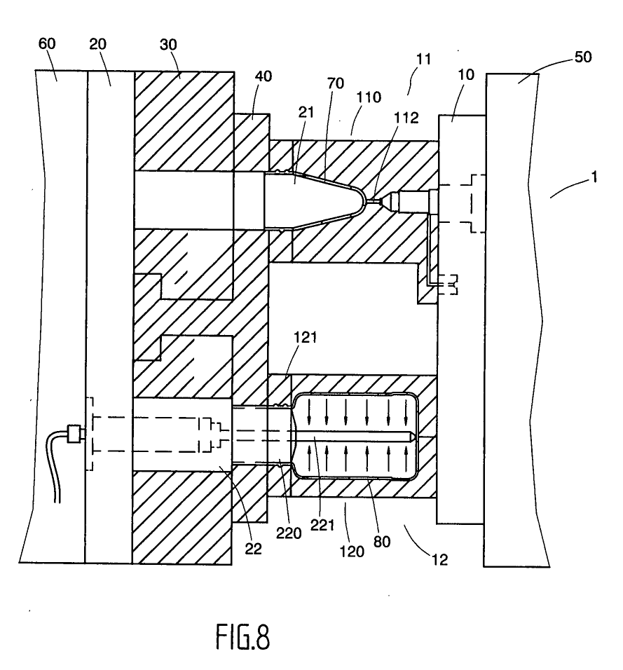

7. Shaping the container: with reference to FIG. 8, the compressed air is injected into the stretched container embryo (70) via the telescopic shaft (220) and the telescopic blowing stick (221) to force the container embryo (70) fully abutting an inner periphery of the blowing mold (120) and shape a complete container (80).

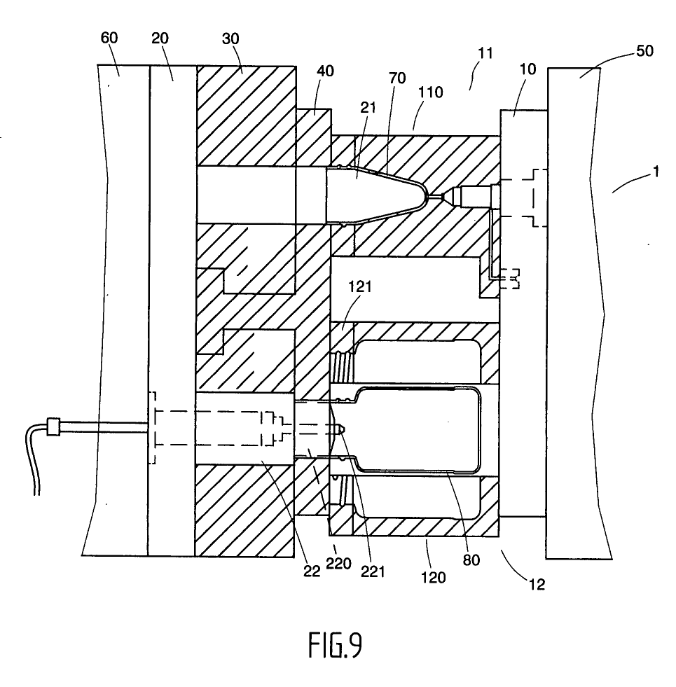

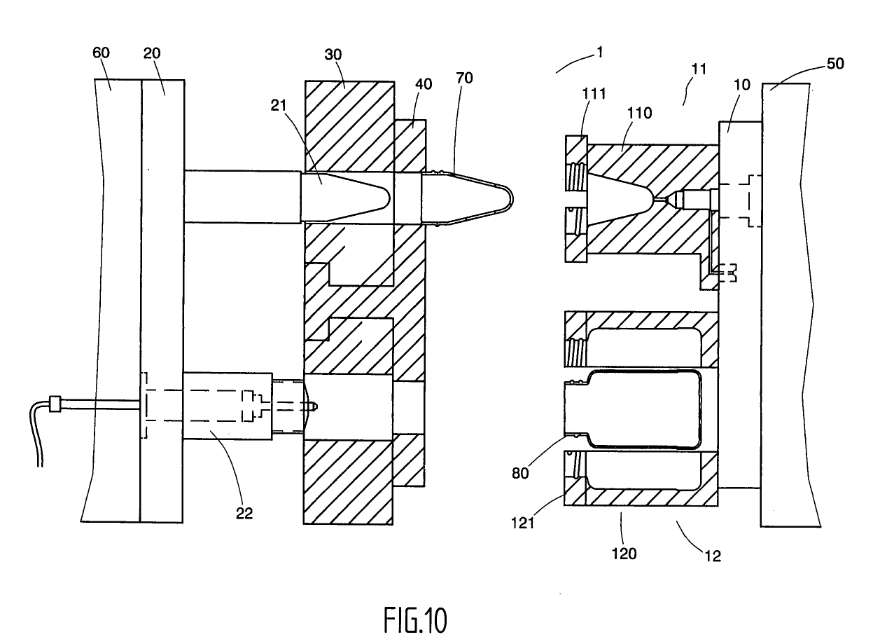

8. Open the mold assembly (1) again: with reference to FIGS. 9 and 10, the telescopic shaft (220) is drawn back and then the telescopic stick (221) is drawn back into the telescopic shaft (220). The blowing mold (120) and the second thread mold (121) are synchronously opened such that the shaped container (80) is detached from the shape molding station (12), but connected to the telescopic shaft (220). Finally, the movable mold seat (60) is backward moved to drive the movable mold board (20), the base mold board (30) and the rotatable mold board (40) moved away from the fixed mold board (10). The movable mold board (20) is continually moved after the base mold board (30) being moved to a fixed position to make the shaped container (80) automatically detach from the telescopic shaft (220). The containers (80) can be continually shaped by repeating the step 4 to step 8.

As described above, the mold assembly of the method in accordance with the present invention can be mounted to an ordinary injection molding machine such that the cost of injection blow molding a plastic container is greatly decreased because a unique injection blow molding machine is unnecessary to the method of the present invention. Consequently, the manufacturer only needs to exchange the mold assembly of the present invention and can produce others products by injection molding.

Although the invention has been explained in relation to its preferred embodiment, it is to be understood that many other possible modifications and variations can be made without departing from the spirit and scope of the invention as hereinafter claimed.

What is claimed is:

1. An injection blow molding method for producing plastic containers, comprising the steps of:
closing mold assembly: the fixed mold board and the movable mold board respectively mounted to the fixed mold seat and the movable mold seat, each core mold received in the embryo mold of a corresponding one of the multiple embryo mold station when the mold assembly is closed;
shaping container embryo: the melted material injected into the embryo mold via the injection nozzle for fully coating the core mold to form a container embryo between the embryo mold and the core mold;
opening the mold assembly: the blowing mold and the embryo mold firstly opened and the movable mold seat backward moved to drive the movable mold board, the base mold board and the rotatable mold board moved away from the fixed mold board, the shaped container embryo moved apart from the embryo mold, the movable mold board continually moved after the base mold board being moved to a fixed position to make each core mold and cylinder escape from the rotatable mold board, the shaped container embryo fixed on the rotatable mold board;
rotating the rotatable mold board: the rotatable mold board accurately rotated 180 degrees to make the shaped container embryo centrally align with the blowing mold;
closing the mold assembly again: the movable mold seat moved toward the fixed mold seat to sequentially the movable mold board, the base mold board and the rotatable mold board to make the rotatable mold board securely abutting against the first thread mold and the second thread mold, the core mold extending into the embryo mold again and the shaped container embryo received in the blowing mold;
stretching the telescopic blowing stick: the telescopic blowing stick extending to a bottom of the blowing mold to stretch the shaped container embryo;
shaping the container: the compressed air injected into the stretched container embryo via the telescopic shaft and the telescopic blowing stick to force the container embryo fully abutting an inner periphery of the blowing mold and shape a complete container; and
open the mold assembly again: the telescopic shaft drawn back and then the telescopic stick drawn back into the telescopic shaft, the blowing mold and the second thread mold synchronously opened such that the shaped container is detached from the shape molding station, but connected to the telescopic shaft, the movable mold seat backward moved to drive the movable mold board, the base mold board and the rotatable mold board moved away from the fixed mold board, the movable mold board continually moved after the base mold board being moved to a fixed position to make the shaped container automatically detach from the telescopic shaft.

2. The method as claimed in claim 1, wherein a new container embryo between the embryo mold and the core mold in the step of stretching the telescopic blowing stick because melted material is injected into the embryo mold via the injection nozzle for fully coating the core mold to form when the telescopic blowing stick stretches.

3. The method as claimed in claim 1, wherein the telescopic shaft of the cylinder extends to engage to a neck of the shaped container embryo for positioning the shaped container embryo during blowing and shaping ins the step of stretching the telescopic blowing stick.
